(19) United States
(12) Patent Application Publication
(10) Pub. No.: US 2015/0018170 A1
(43) Pub. Date: Jan. 15, 2015

(54) HYBRID DRIVE FOR A WATER VEHICLE

(71) Applicant: Volker Höfer, Boppard (DE)

(72) Inventor: Volker Höfer, Boppard (DE)

(21) Appl. No.: 14/380,650

(22) PCT Filed: Sep. 24, 2012
(86) PCT No.: PCT/EP2012/068796

§ 371 Date: Aug. 22, 2014

(30) Foreign Application Priority Data
Feb. 22, 2012 (DE) 10 2012 101 427.2

(51) Int. Cl. B60K 6/42; B63H 21/14; B63H 21/17

(52) U.S. Cl. CPC B60K 6/42; B63H 21/17; B63H 21/14; Y10S 903/902
USPC 477/5; 180/65.22; 903/902

(57) ABSTRACT

A hybrid drive for a watercraft, including a primary drive motor, which is situated inside the watercraft and drives a drive shaft, and an above-water transmission, which is situated after the drive shaft and has a transmission housing, for driving a vertical shaft branching off from the above-water transmission, as well as an electric secondary drive motor, which has a stator and a rotor and is able to drive the vertical shaft in addition to or alternatively to the primary drive motor. The secondary drive motor can be embodied with a hollow shaft and the stator of this motor can be coupled in a torsionally rigid fashion to the transmission housing of the above-water transmission.

### BACKGROUND OF THE INVENTION

1. Field of the Invention

This invention relates to a hybrid drive for a watercraft, including a primary drive motor, which is positioned inside the watercraft and drives a drive shaft, and an above-water transmission which is positioned after the drive shaft and has a transmission housing, for driving a vertical shaft that branches off from the above-water transmission. as well as at least one electric secondary drive motor that is able to drive the vertical shaft in addition to or alternatively to the primary drive motor.

2. Discussion of Related Art

A hybrid drive of this generic type is known, for example, from PCT Patent Reference WO 2011/021727 A1 and is used to drive a rudder propeller whose propeller shaft is situated outside the hull and is driven via the vertical shaft by the primary drive motor and/or secondary drive motor situated inside the watercraft, with the interposition of the above-water transmission. Via clutches, the primary drive motor, which is usually formed as an internal combustion engine, and the electric motor connected to a second drive shaft can be brought into a frictional, non-positive engagement with the vertical shaft in order, depending on the operating mode of the watercraft, to run on the primary drive motor, the electric secondary drive motor, or both motors.

A similar apparatus, likewise operating with two drive shafts, which are selectively switchable via clutches, for the primary drive motor and the secondary drive motor, is known from German Patent Reference DE 10 2009 000 992 A1.

One disadvantage of these known hybrid drives is that the plurality of drive shafts and associated clutches provided in the above-water transmission represent a high degree of design complexity that is not only cost-intensive, but also requires a corresponding amount of space so that in confined installation situations, such as in harbor tugs, hybrid drives of this kind can only be used to a limited degree and require a special design of the hull. Thus, as a rule, a watercraft that is only equipped with an internal combustion engine as the primary drive motor either cannot be subsequently retrofitted with such a hybrid drive at all or can only be retrofitted with one at great expense.

On the other hand, there has recently been increased demand for such hybrid drives, particularly in watercraft used in inland waterways and harbors, such as within environmental protection zones in harbors, in which they are operated at partial throttle a large amount of the time. For example, the usage profiles of harbor tugs show large percentages of time at low outputs so that hybrid drive concepts with a diesel engine for bollard pull conditions and an electric motor for lower output requirements offer the possibility of operating in an energy-efficient, resource-saving fashion.

### SUMMARY OF THE INVENTION

One object of this invention is to provide a hybrid drive of the type mentioned above but which overcomes the disadvantages of the prior art and features a particularly space-saving, reasonably priced embodiment.

The stated object is attained according to this invention by embodiments of a hybrid drive according to features as described in this specification and in the claims.

In some embodiments of this invention, there is at least one electric secondary drive motor with a hollow shaft, which according to one embodiment of this invention, is an internal rotor motor with a rotary driven hollow shaft and a motor housing serving as a stator. Alternatively, however, a torque motor embodied as an external rotor motor can be provided, with a hollow shaft serving as the stator and a housing serving as the rotor.

One main advantage of embodiments according to this invention is that the secondary drive motor does not require any additional meshing, but instead shares the use, so to speak, of the meshing that is already provided anyway for the primary drive motor.

In the context of this invention, the term “meshing” relates to a flow of power achieved by the meshing of a transmission between the drive motor and the vertical shaft in order to drive the watercraft.

The secondary drive motor according to this invention shares the use of the meshing transmission components that are provided for the primary drive motor, thus achieving a significant simplification of the design.

In any case, according to this invention, the stator of the secondary drive motor, depending on the embodiment, either the motor housing or the hollow shaft, is coupled in a torsionally rigid fashion to the transmission housing of the above-water transmission so that it is no longer necessary to provide additional containing spaces and fastening elements for the secondary drive motor. The hybrid drive according to this invention can thus be embodied in a particularly space-saving way and can be retrofitted onto already existing primary drives.

In particular, according to one embodiment of this invention, the available internal space inside the hollow shaft of the secondary drive motor is used to accommodate a clutch or a brake of the drive shaft or the vertical shaft, for example, a component that is present anyway in a conventional design of an above-water transmission with a drive shaft driven by the primary drive motor. Possible positions for the electric secondary drive motor are thus the power input end, such as the entry of the drive shaft into the above-water transmission, the end opposite from the power input, or the vertical positions on the above-water transmission, in which the end of the vertical shaft is guided.

Due to the design of the secondary drive motor with the hollow shaft and the stator, which is connected to the transmission housing of the above-water transmission in a torsionally rigid fashion, the hybrid drive according to this invention does not inherently require additional seals and also does not require any additional meshing or additional shafts in the above-water transmission. In addition, the secondary drive motor requires no additional clutches.

The secondary drive motor also does not require separate bearings, but instead is integrated into the already existing bearings of the system comprising the primary drive motor, the drive shaft, the above-water transmission, and the vertical shaft. Because of the integration of the secondary drive motor according to this invention, so that the flow of power travels via only one gear set of the above-water transmission regardless of whether the primary and/or secondary drive motor is used, this also eliminates the need for additional adjustments for the no longer necessary gear set of the secondary drive motor. In addition, there are no simultaneously idling meshing components, for example, when the primary or secondary drive motor is switched off, which results in lower noise emission and a higher efficiency of the hybrid drive according to this invention.

The electric secondary drive motor used according to this invention can be a permanently excited synchronous motor such as a so-called torque motor.

Torque motors are intrinsically known and are used, for example, as transmissionless drive motors in machine tools, extruders, and roller drives used in the plastics processing industry since they make it possible to produce high torques in a defined speed range while requiring only a small amount of space. When embodied as an internal rotor motor, a torque motor of this kind is usually comprised of a stator, which is equipped with coils and comprised of the motor housing, and a rotor, which is equipped with permanent magnets and comprised of a hollow shaft. When embodied as an external rotor motor, a torque motor of this kind has a hollow shaft, which is equipped with coils and serves as the stator, and a housing, which is equipped with magnets and serves as the rotor.

In the context of this invention, such a motor can also be adapted as an electric secondary drive motor for use in a hybrid drive for watercraft because it only requires a small amount of space, is able to produce a high torque in the relevant speed range, and due to its specific embodiment with a hollow shaft, is particularly easy to integrate into existing, proven designs of above-water transmissions.

If the clutch of the drive shaft leading to the primary drive motor is positioned inside the hollow shaft of the secondary drive motor, then the electric secondary drive motor can be integrated into the hybrid drive without a separate clutch, thus achieving further parts savings and requiring even less space.

Alternatively, the secondary drive motor can also be placed with its hollow shaft onto the drive shaft or the vertical shaft, thus providing the greatest possible flexibility with regard to the installation position.

According to this invention, the term “vertical shaft” should not be understood to be restricted to a shaft with a precisely vertical orientation, but also includes shafts that have an orientation that deviates from the vertical.

In general, the hybrid drive according to this invention is suitable for all designs, in particular azimuth thrusters for ships.

In the context of this invention, not only can the electric secondary drive motor, operating in tandem with the primary drive motor, for example as a so-called booster, support the drive with the primary drive motor, for example in order to produce peak torques and outputs, but also, with a corresponding disengagement of the primary drive motor, it is possible to use a purely electrical operation with the secondary drive motor. Furthermore, in one embodiment of this invention, the secondary drive motor, in a different mode, can also be operated as a generator, for example, in order to supply the electrical system of the watercraft with electrical energy or in order to charge batteries for subsequent electrical drive operation of the secondary drive motor.

Naturally, the hybrid drive according to this invention can be not only a stand-alone drive unit, but also can be with a plurality of hybrid drives in a corresponding watercraft. In a multiple configuration of this kind, it is also possible to operate the electric secondary drive motor of one hybrid drive as a generator and with the generated electrical energy, to ensure a purely electrical drive of the second hybrid drive with the secondary drive motor. In such an operating mode, despite the fact that the drive is provided by two hybrid drives according to this invention, it is possible to achieve a significant reduction in fuel consumption and emissions.

The secondary drive motor according to this invention can also function as a cold start device and can accelerate the disengaged shaft section to a speed synchronized with that of the shaft with which the engagement is to be produced, thus making it possible to use a smaller clutch or even a shift clutch in lieu of a slip clutch.

The hybrid drive according to this invention can be provided with various designs of above-water transmission. In the context of this invention, an “above-water transmission” is generally understood to be the transmission of an azimuth thruster, with the transmission being situated inside the ship or watercraft.

One example of such an azimuth thruster is a rudder propeller. In this connection, the hybrid drive according to this invention can be embodied in the form of a so-called Z-drive, such as a drive with two bevel gear stages in the entire rudder propeller, or in the form of a so-called L-drive, such as a drive with only one bevel gear stage in the entire rudder propeller.

### BRIEF DESCRIPTION OF THE DRAWINGS

Other embodiments and details of the hybrid drive according to this invention is explained in greater detail below in view of exemplary embodiments shown in the drawings, wherein:

FIG. 1 is a schematic depiction of an above-water transmission of a hybrid drive according to this invention;

FIG. 2 is a schematic depiction of another embodiment of an above-water transmission of a hybrid drive according to this invention; and

FIG. 3 is a front view of a torque motor according to this invention.

### DETAILED DESCRIPTION OF THE INVENTION

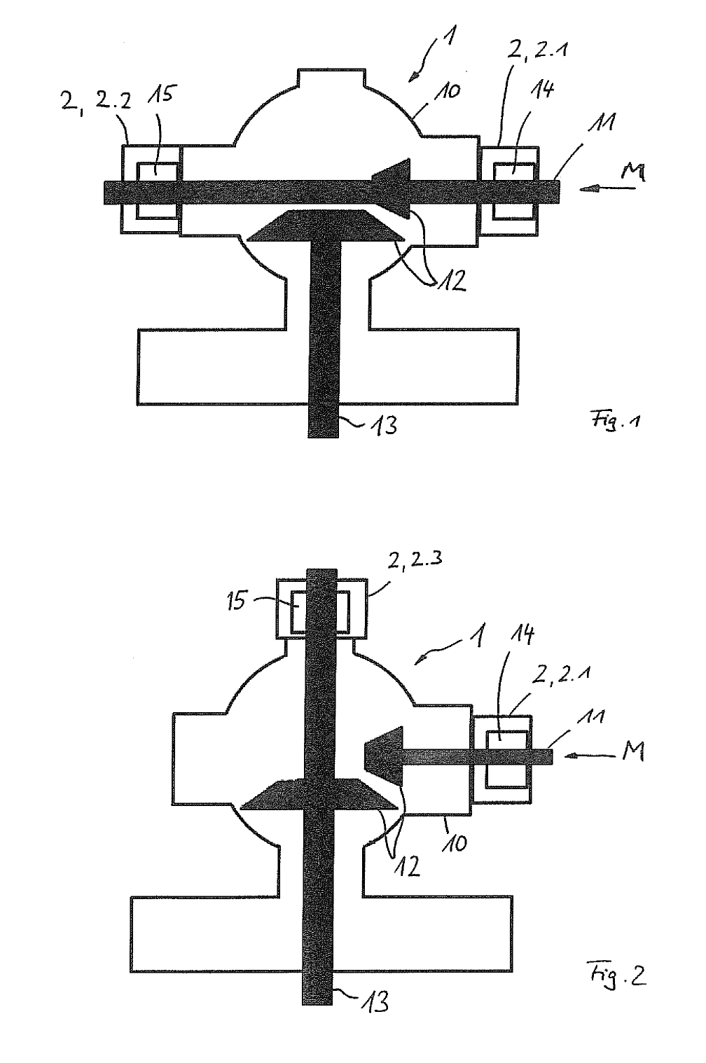

FIG. 1 schematically depicts an above-water transmission of a hybrid drive in which the above-water transmission 1 includes a drive shaft 11 extending in an essentially horizontal orientation inside the transmission housing 10, which is embodied as an L-drive and, via an angular drive 12 with bevel gears, drives a vertical shaft 13 that is oriented vertically and extends out from the housing 10 of the above-water transmission 1. The components shown in the drawing are usually accommodated on the inside of a watercraft that is not shown in the drawings.

In a manner that is not shown in detail, the vertical shaft 13 extends to a conventionally designed rudder propeller situated or positioned outside of the watercraft, or more precisely underneath the hull, for example, as shown in German Patent Reference DE 20 2009 009 031 U1.

In a manner that is not shown in detail, the drive shaft 11 is driven by the output and torque M of a primary drive motor, which is not shown here and is likewise accommodated inside the watercraft, for example embodied in the form of an internal combustion engine.

The drive shaft 11 can be engaged and disengaged by a clutch 14 so that depending on the switching state of the clutch 14, the primary drive motor can be engaged with the vertical shaft 13 by frictional, non-positive engagement or can be disengaged from the vertical shaft 13.

In order to now create a hybrid drive with an electric secondary drive motor provided in addition to the primary drive motor and with a particularly space-saving design, a torque motor whose essential components are shown in FIG. 3 is used as the electric secondary drive motor 2 and has a motor housing 21 serving as the stator, which accommodates a rotary driven hollow shaft 20 on its interior. An internal chamber 22 is thus provided inside the rotary driven hollow shaft 20 so that the torque motor can be positioned, for example, at a suitable location on the drive shaft 11 and connected to the latter when the drive shaft 11 extends through the internal chamber 22.

Naturally, instead of the torque motor, it is also possible to use other electric secondary drive motors 2 equipped with a hollow shaft 20.

In a particularly advantageous embodiment, such an electric secondary drive motor 2, which is embodied as an internal rotor motor, is connected by its motor housing 21 to the transmission housing 10 of the above-water transmission 1 in a rotationally rigid fashion, for example, is fastened to it with screws, and is positioned in a location in which the above-water transmission 1 is equipped with additional internal components such as clutches 14 or brakes 15 that are required for supporting and/or operating the drive shaft 11 and/or vertical shaft 13.

The reference numeral 2.1 in FIG. 1 schematically indicates an installation position for the electric secondary drive motor 2 in which the internal chamber 22 of the rotary driven hollow shaft 20 accommodates the above-described clutch 14 of the drive shaft 11, such as the secondary drive motor 2 encompasses the clutch 14 in the installation position in which it is provided anyway, but is connected in a torsionally rigid fashion to a clutch part, such as the clutch housing or the power input shaft.

This makes it possible to achieve an extremely space-saving installation of the electric secondary drive motor 2, which makes it possible, for example, to also retrofit it onto an already existing conventional drive for the watercraft that has only a primary drive motor. In this arrangement, with the clutch 14 for the drive shaft 11 being situated inside the internal chamber 22, the electric secondary drive motor 2 provided according to this invention also does not need a separate clutch, but can instead, depending on the operating state of the existing clutch 14, produce the rotary drive of the drive shaft 11 in addition to the primary drive motor or alternatively to it, so it is possible to increase the drive output of the primary drive motor by the electric secondary drive motor, such as to enable a so-called booster operation, and also to ensure a purely electrical travel mode that features particular energy savings and low emissions when not much thrust is needed.

Alternatively, the secondary drive motor 2 can also be provided at the installation position labeled with the reference numeral 2.2 at the opposite end of the transmission housing 10 of the above-water transmission 1, where a brake 15 for the drive shaft 11 is usually provided. In this position as well, the internal chamber 22 inside the hollow shaft 20 of the secondary drive motor 2 encompasses the brake 15 and/or pivot bearing provided there.

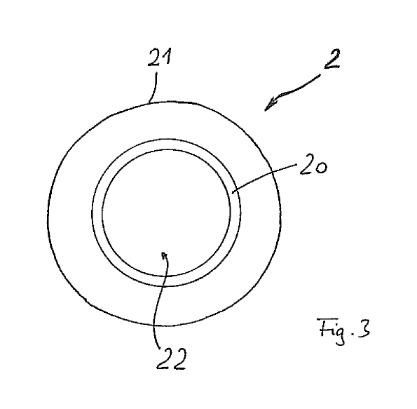

In a modification relative to the exemplary embodiment according to FIG. 1, FIG. 2 shows an embodiment of an above-water transmission 1 in which the drive shaft 11 is only guided into the transmission housing 10 until it reaches the angular drive 12, but does not extend out from the transmission housing 10 at its opposite end. Instead, in this exemplary embodiment according to FIG. 2, the vertical shaft 13 extends out from the transmission housing 10 in the upper region of the latter and at this location, is supported by a brake 15 or a pivot bearing that is not shown here.

In addition to the installation position 2.1 of the electric secondary drive motor 2 in the region of the clutch 14 of the drive shaft 11, which has already been shown in FIG. 1 and explained in conjunction therewith, in the exemplary embodiment shown in FIG. 2, it is possible to also provide this secondary drive motor 2 at the installation position labeled with the reference numeral 2.3, such as encompassing the brake 15 mounted on the transmission housing 20 so that here, too, an extremely small amount of space is required.

As an alternative to the above-described design of the secondary drive motor 2 as an internal rotor motor with a rotary driven hollow shaft 20 serving as the rotor and a motor housing 21 serving as the stator, it is also possible to use the motor housing 21 as the rotor and to connect the hollow shaft 20, which serves as the stator, to the transmission housing 10. In this case, the secondary drive motor 2 is embodied as an external rotor motor.

All of the embodiments described above feature the fact that the secondary drive motor 2 functions without additional meshing in the above-water transmission, but instead shares the use, so to speak, of the meshing of the primary drive and only uses the drive components that are also used in the operation of the primary drive motor. For this reason, the secondary drive motor also does not require any separate bearings.

As already mentioned, the above-explained installation positions 2.1, 2.2, 2.3 for the electric secondary drive motor 2 are suitable not only for new designs of above-water transmissions for a hybrid drive of a watercraft, but also permit existing above-water transmissions equipped with only a primary drive motor to be retrofitted with an extremely low degree of design complexity and in a way that requires an extremely small amount of additional installation space, thus converting them into hybrid drives, thus making it possible, for example, to retrofit harbor tugs that have only a limited amount of space available inside the hull for the above-water transmission.

Since harbor tugs are generally only operated with 60-70% of the total power available, the primary drive that is usually embodied in the form of an internal combustion engine can be embodied with correspondingly smaller dimensions because in this case, the maximum output that is only needed on rare occasions can be produced by the additionally provided electric secondary drive. It is also possible to operate in a purely electric mode in special environmental zones.

The above explained invention also offers an additional potential optimization. It is thus possible when engaging the clutch, for the provided electric secondary drive to accelerate the drive shaft, for example, to the shifting speed before the clutch 14 is engaged, thus making it possible to use a technically simpler and less expensive shift clutch in lieu of the previously used slip clutches.

It is also possible to operate the electric secondary drive motor 2 in an additional operating mode in which it is used as a generator in order to supply power to the electrical system of the watercraft or to charge the provided batteries.

If a watercraft is equipped with more than one such hybrid drive, for example, two rudder propellers that are each powered by such a hybrid drive, then there is a possibility of an electrical coupling in which only one primary drive motor is operational, whose associated electric secondary drive motor produces power in the generator mode and with it, drives the electric secondary drive motor of the second rudder propeller.

Because the previously explained above-water transmission of such a hybrid drive only requires one drive shaft 11, such an above-water transmission does not have any simultaneously idling bevel gears and correspondingly also does not have a load-free setting so that it is possible and extremely easy to retrofit existing drives. The electric secondary motor provided always engages the same gear component that would also be active during operation with the primary drive motor. The degree of design simplification that this achieves is significant and results in significantly lower complexity and significantly reduced costs.

1. A hybrid drive for a watercraft having a primary drive motor positioned inside the watercraft and drives driving a drive shaft (11), and an above-water transmission (1) positioned after the drive shaft and having a transmission housing (10), for driving a vertical shaft (13) that branches off from the above-water transmission (1), and as at least one electric secondary drive motor (2) having a stator and a rotor and able to drive the vertical shaft (13) in addition to or alternatively to the primary drive motor, the hybrid drive comprising the at least one electric secondary drive motor (2) having a hollow shaft (20) and the stator coupled a torsionally rigid to the transmission housing (10) of the above-water transmission (1).

2. The hybrid drive according to claim 1, wherein the secondary drive motor (2) is an internal rotor motor with a rotary driven hollow shaft (20) and a motor housing (21) serving as the stator.

3. The hybrid drive according to claim 1, wherein the secondary drive motor (2) is an external rotor motor having a rotary driven motor housing (21) serving as the rotor and a hollow shaft (20) serving as the stator.

4. The hybrid drive according to claim 3, wherein the secondary drive motor (2) is a permanently excited synchronous motor.

5. The hybrid drive according to claim 4, wherein the secondary drive motor (2) is a torque motor.

6. The hybrid drive according to claim 5, wherein the inside of the hollow shaft (20) of the secondary drive motor (2) accommodates a clutch (14) or a brake (15) of the drive shaft (11) or the vertical shaft (13).

7. The hybrid drive according to claim 6, wherein the secondary drive motor (2) is positioned with the hollow shaft (20) on the drive shaft (11) or the vertical shaft (13).

8. The hybrid drive according to claim 7, wherein in one operating mode, the secondary drive motor (2) can be operated as a generator.

9. The hybrid drive according to claim 8, wherein the secondary drive motor (2) has no separate bearings.

10. The hybrid drive according to claim 1, wherein the secondary drive motor (2) is a permanently excited synchronous motor.

11. The hybrid drive according to claim 1, wherein the secondary drive motor (2) is a torque motor.

12. The hybrid drive according to claim 1, wherein the inside of the hollow shaft (20) of the secondary drive motor (2) accommodates a clutch (14) or a brake (15) of the drive shaft (11) or the vertical shaft (13).

13. The hybrid drive according to claim 1, wherein the secondary drive motor (2) is positioned with the hollow shaft (20) on the drive shaft (11) or the vertical shaft (13).

14. The hybrid drive according to claim 1, wherein in one operating mode, the secondary drive motor (2) can be operated as a generator.

15. The hybrid drive according to claim 1, wherein the secondary drive motor (2) has no separate bearings.
